(19) United States
(12) Patent Application Publication
(10) Pub. No.: US 2016/0262354 A1
(43) Pub. Date: Sep. 15, 2016

(54) Joeysack

(71) Applicant: Nancy M. Rojas, Ormond Bch, FL (US)

(72) Inventor: Nancy M. Rojas, Ormond Bch, FL (US)

(21) Appl. No.: 14/756,346

(22) Filed: Feb. 10, 2015

(51) Int. Cl. A01K 29/00

(52) U.S. Cl. CPC A01K 29/00

(57) ABSTRACT

I have designed a set of processes that creates an animal carrier/sleep therapy bag and supporting system. Works like magic. Soothing and safe like a comfy blanky.

### BACKGROUND OF THE INVENTION

Problem solved: the design allows pet owners and shelters and rescues to carry small dogs or cats or critters safely and very comfortably for both animal and human.

Problems with other dog carriers include bulk, expense to purchase and very uncomfortable design. Some carries make the animal feel trapped while others have the dog hanging inside a net. Mine make the animal feel comfort, safety and grant territory to be transferred from home to away from home. The Joeysack incorporates fashion and marries it to function like nothing else in the pet catalogue of products. Individuals who carry therapy animals into retail environments will find easy access to their pet while providing a camouflaged presence for the animal. The animal is calm and safe in its carrier and may be touched easily and clandestinely.

### DETAILED DESCRIPTION OF THE INVENTION

As stated above, the design allows dog owners and shelters and rescues to carry small dogs (i.e. 10 lbs and under safely because of the design.) The invention claimed here solves this problem. The bag is a multi-unit, very simple and comfortable and will transport the desired animal as promised all the while providing a fashionable garment for the wearer. The claim invention differs from what currently exists. My product is a re-purposed hoody and an inner bed sack either lightly stuffed or not stuffed to provide stability when worn. The inner bag also serves a second purpose as it may be used as the dog's bed home and away from home limiting the stress of new smells and environments.

This carrier can move freely in and out of retail for therapy/anxiety dogs or easy air travel once in the air. Recreational endeavors also will be included. Owner can ride a bike or take walks all the while comfortably wearing the dog with minimal additional stress factors to the wearer.

Because of the broad spectrum my product has the capability of addressing, both homeless babies looking for a furever home as well as pampered couture dogs may benefit. The Joeysack branded with a line of products affiliated with Yapper Wear and The Yapping Chihuahua.com will all seek to improve animal welfare through the product itself and through the venture into retail sales and profits. Beta testing has been extremely positive with both animals and humans giving positive responses. Basically, through licensing and branding, for this product, the sky really is the limit.

The Version of the Invention discussed here includes:
1. Hood
2. Pockets
3. Long sleeves
4. Higher end fabric choices and quality ornamental embellishments

Relationship between the components:

The bag when carrying and the insert is one unit. The insert is a removable dog sleeping sack which can be used alone.

How the invention works:
1. Each piece added or subtracted is for the purpose of comfort, security and transportability through a fashionable medium.

How to make the invention/Specifications:

A fabricated jacket consisting of pockets, full zipper and hood is required. Style and fabric content are under guidelines and discretion of designer.
a) Hoody sleeves are to be reinforced at the shoulder/sleeve seam with thread in a zig zag, elastic stitch or similar stitch.
b) Bottom of jacket to be sewn in same manner as sleeves with straight stitch first and then a reinforcing zig zag, elastic or similar stitch.
c) A straight stitch is sewn inside jacket in a semi-circle from side to side to bring jacket to a rounded base reducing bulk.
d) Sleeves insert into one another with right sleeve twisted once to form cross body strap. One cuff is left unsewn. At side of cuff reinforcement stitch or top stitch overlock.
2. The second component of the Joeysack is the inner sleep bag. The construction of inner insert may include multiple sizes or re-purposed goods, i.e. pillow shams to form the bag and qualify for the claim. For the Joeysack to be of retail quality, the following steps must be followed as Joeysack is dependent on all steps in outer bag combined with all steps from inner bag and proper assembly, all components, fabrics, battings, stitches once combined are dependently proprietary and have been brought together by my design.
a) Quilted fabric, batted and quilted are a main component of the inner bag. The bag contains a lining. Either the outer design or the lining must be of a quilted and batted fabric.
b) The cutting of the inner bag in a scalloped edge pattern is for the purpose of easy entry of the pet. It allows the bag to be entered in easily when removed from the outer bag. This duplicity in design, both as an insert and sleep sack is aided by the scalloped edge. Cut measurements are 26×22″.
c) The outer and lining fabrics are joined and post sewing two pockets are added on each side. Left pocket 10×5″ and the right pocket 10×3.5″. These are lightly stuffed with fiberfill or similar filling agent.
d) Top stitch all around the bag.
e) Fold bag in half evenly and straight stitch at scalloped edge from bottom to 10.5″ up.
f) Sew base 1.5″ from edge and stop at 3.5″ from edge. Turn right side out. Apply logo and label or other decorative agents.

How to use invention:

Buy it. Place the outer bag in a cross body position over desired shoulder. At this point the inner back is outside of the outer. Set hoody behind bag or up on your chest while inserting animal. The zipper must be halfway up. Hold the animal so that it drops to the bottom and cinch the top with your hand leaving only the animal's head showing. Drop animal in sack and zip all the way up. Typically just a head will be visible depending on what type of critter is in the bag. If you desire that the animal is not visible, lower hoody. Pockets are made available for cell phones, wallets, waste bags, etc. an added feature might include a tether or collapsible water bowl clipped to the bag. Additionally, because it carries things, it could be used for children's toys and toy puppies, etc. Joeysack can be modified to become a sleep pillow for a child and a jacket when not carrying an item. Other uses include air travel once plane is in the air. The calling this bag provides makes air travel a breeze. By the use of the invention it can create though licensing and branding of the concept, additional products and future expandability to the parent company The Yapping Chihuahua LLC whose sole goal is to effect positive change in animal welfare and the goal of sentient recognition worldwide.

### BRIEF DESCRIPTION OF DRAWINGS

FIG. 1. Shows Joeysack worn with animal inserted and worn as a crossbody garment on front, side or back of wearer.

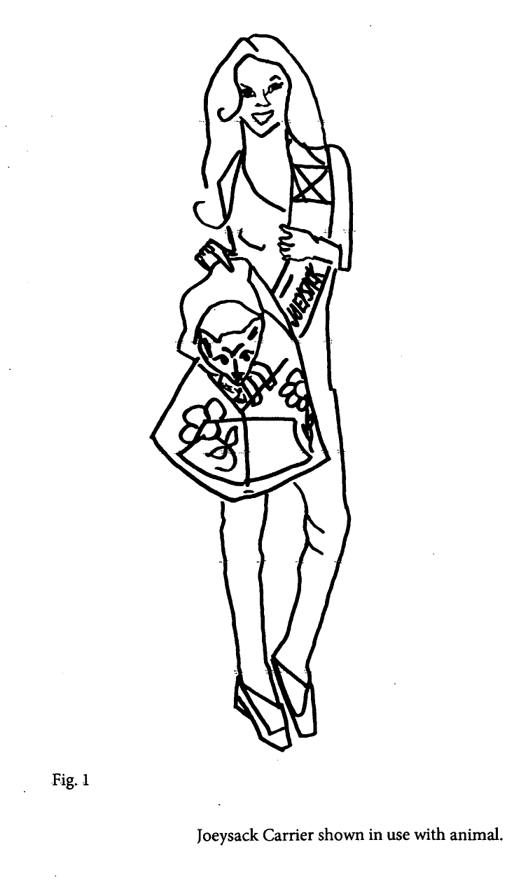

FIG. 2 shows basic requirements of hoody
1) Hood
2) Pockets
3) Long sleeves

FIG. 3. Shows reinforcements and adjustments to jacket.
1) Sleeves inserted one inside the other. One cuff left free to fold backward. Rectangle and “X” sewn 4″ long and width of sleeve.
2) Sleeves reinforced with zig zag or similar stitch.
3) Full length heavy duty jacket zipper.
4) Jacket sewn inside to close and form base. Reinforce with straight and zig zag or similar stitch.
5) On inside sew semi-circle on each side from base to 5″ up to sides.

FIG. 4 shows completed insert bag with scalloped edges and logo.

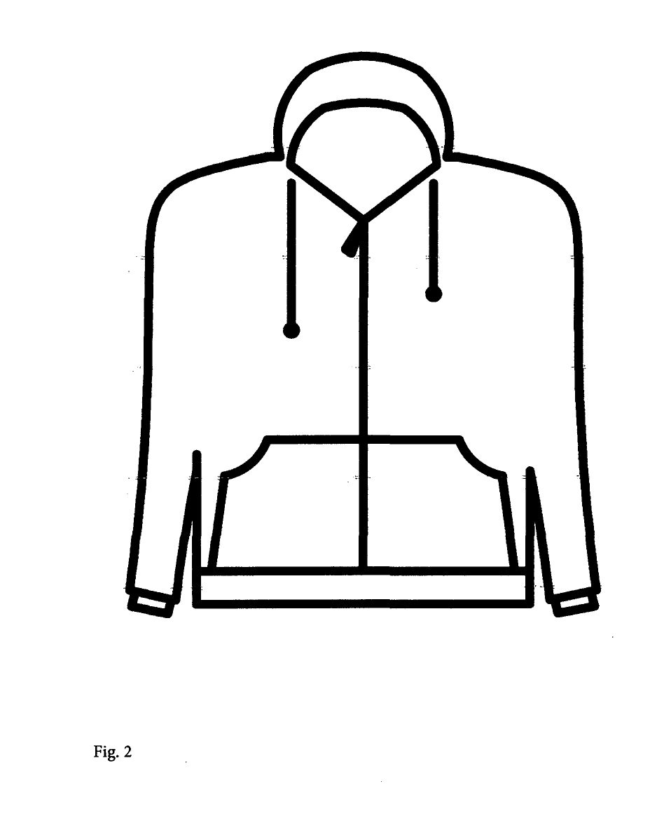

FIG. 5. Shows inner sleep bag prior to sewing using quilted fabric and two pillow pockets on inside.

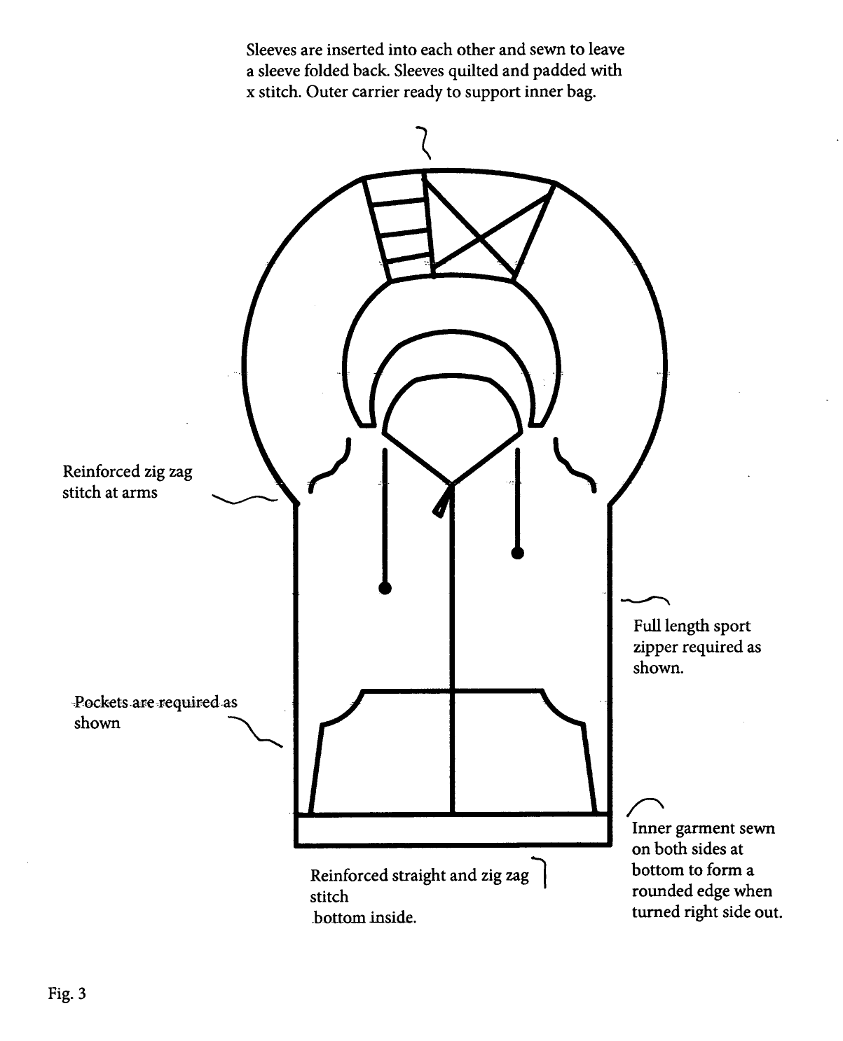

FIG. 6 shows inner sleep bag as double sided quilted fabric with or without stuffed sewn in bias tape trim.

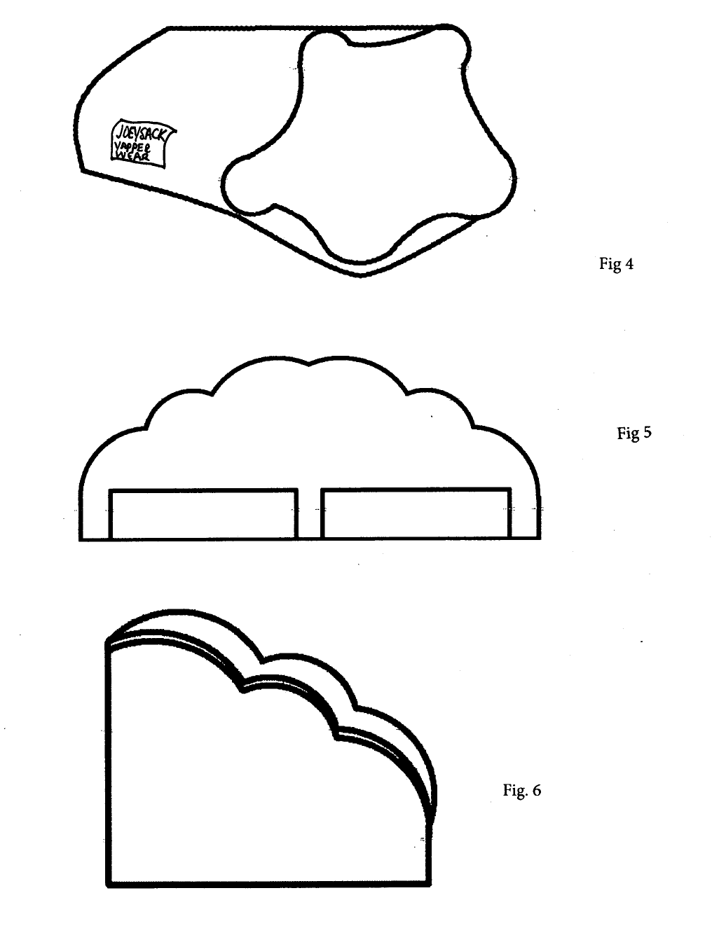

1. The Joeysack accomplishes a unique way to provide comfort, transportation and calming to humans and animals by a series of steps which can only be done via the processes explained and defined by definitions and supporting diagrams and specifications. Without the inner bag, sewn and constructed as described ,whether in similar or direct form and without the construction of a “hoody” like outer bag and inner insert bag, the Joeysack does not function as claimed. The Joeysack is not one thing, but a series of “things” or “processes” which combined create this product. Each separately is not a Joeysack and does not provide or meet the claim of a functional, fashionable animal carrier and anxiety/therapy bag.
